(19) United States
(12) Patent Application Publication
(10) Pub. No.: US 2020/0380580 A1
(43) Pub. Date: Dec. 3, 2020

(54) SYSTEM AND METHOD FOR MANAGING SERVICES IN AN ONLINE SERVICING SYSTEM

(71) Applicant: Wipro Limited, Bangalore (IN)

(72) Inventors: Arnik Sarkar, Murshidabad (IN); Pranab Ghosh, Kolkata (IN); Dipanjan Choudhury, Siliguri (IN)

(21) Appl. No.: 16/515,462

(22) Filed: Jul. 18, 2019

(30) Foreign Application Priority Data
May 31, 2019 (IN) 201941021746

(51) Int. Cl. G06Q 30/06; G06F 16/9535

(52) U.S. Cl. CPC G06Q 30/0631; G06N 3/04; G06Q 30/0609; G06F 16/9535

(57) ABSTRACT

Embodiments of present disclosure relates to system and method for managing services in online servicing system. Service-context data is determined for service request received for service from consumer, which is determined based on real-time parameters affecting the service and a service data associated with service of consumer. Further, consumer preferences associated with consumer and service provider preferences associated with one or more service providers are determined, The consumer preferences is determined based on service-context data and consumer data which comprises past behavioural attributes of the consumer relating to the service. The service provider preferences are determined based on service-context data and service provider data which comprises past behavioural attributes of each of the service providers relating to the service. The consumer preferences are matched with the service provider preferences to identify an optimum service provider from service providers. The optimum service provider is configured to provide service to consumer.

### TECHNICAL FIELD

The present disclosure relates generally to managing services in an online servicing system and more specifically to identify an optimum service provider for a service requested by a consumer.

### BACKGROUND

Online servicing systems such as transportation booking service, online shopping service, online medical assistance, food ordering service, delivery assisting service and so on, have been widely used amongst customers. Each of the online servicing systems include registered service providers. When a request for a service is received from a consumer, one of the registered service providers may be assigned to the consumer. In some servicing systems, service provider may be a human-being or a machine behaving like a human-being and the consumer may be either a human-being or a device emulating or behaving like a human-being.

Choosing of the service provider for a particular service opted by the consumer may depend on various factors. For example, for a transportation booking service, the customer may be a user who has booked a ride to a desired destination using a cab-service application and the service providers may be cab drivers who have registered with the cab-service application. When the user makes a request for ride, the service provider, that is a cab driver, who may be nearest to current location of the user may be assigned to the user for the ride. Other factors considered for such service may include personal-preferences of the user, on-demand content, and so on.

In some online servicing systems, nature of selection of a service provider to the service opted by the consumer and fulfilment of such service is highly dependent on personal preferences and specific need to the consumer. In certain scenarios, where the service provider is a human-being, service fulfilment becomes more challenging due to consideration of personal preference of both the consumer and the service provider.

In order to achieve effectiveness of online service provided to the consumer, quality of service and customer satisfaction, it may be essential to have appropriate match of preference among the consumer and the service providers.

Conventional systems dealing with matching the service provider to the consumer may be configured to collect consumer preferences beforehand, through online methods. Such consumer preferences may also be extracted from feedbacks provided by the consumer, through the online methods. The consumer preferences as gathered are considered while performing preference match between the consumer and the service provider. Some systems disclose to gather preferences from service providers as well and perform mutual match of static preferences of the consumer and the service providers.

Other conventional systems disclose to maintain set of static preferences for the service providers and the consumers for different service-contexts based on inputs and feedbacks received from the consumer and the service providers. The service-contexts may be real-time parameters that have effect on the preferences of the customer and the service providers. For example, the service contexts may be type of day, time of day, weather conditions, locality, nature of destination and so on.

Preference data may be updated by the user directly or based on the feedback provided by the user in the services against different parameters under different service-context. However, such conventional systems maintain preferences statically for different service-context. In industry scenario, number of contexts can be unlimited or at least extremely high and number of possible preferences may be very large. Hence, the number of context-based profiles to be maintained is likely to be very large and also the profile size can become unusable causing delay in loading and matching of the consumer with a service provider. This is likely to lead to performance related issues and overhead when assigning a service provider to the consumer. Another issues likely to arise is absence of a mechanism in such conventional system to identify an appropriate profile-match in a service-context that has not been encountered before. This may lead to service impact. By such conventional systems, preference matching performed for the consumer with the service providers may be inadequate for maintaining desired service quality and satisfaction of both the consumer and the service providers.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure relates to a method of managing services in an online servicing system. Initially, a service-context data is determined for a service request received for a service from a consumer in an online servicing system. The service-context data is determined based on one or more real-time parameters affecting the service and a service data associated with the service of the consumer. Further, one or more consumer preferences associated with the consumer and one or more service provider preferences associated with one or more service providers are determined. The one or more consumer preferences is determined based on the service-context data and consumer data which comprises past behavioural attributes of the consumer relating to the service. The one or more service provider preferences are determined based on the service-context data and service provider data which comprises past behavioural attributes of each of the one or more service providers relating to the service. The one or more consumer preferences are matched with the one or more service provider preferences to identify an optimum service provider from the one or more service providers. The optimum service provider is configured to provide the service to the consumer.

In an embodiment, the present disclosure relates to service management system for managing services in an online servicing system. The system includes a processor and a memory communicatively coupled to the processor. The memory stores processor-executable instructions, which on execution cause the processor to manage the services in the online servicing system. Initially, a service-context data is determined for a service request received for a service from a consumer in an online servicing system. The service-context data is determined based on one or more real-time parameters affecting the service and a service data associated with the service of the consumer. Further, one or more consumer preferences associated with the consumer and one or more service provider preferences associated with one or more service providers are determined. The one or more consumer preferences is determined based on the service-context data and consumer data which comprises past behavioural attributes of the consumer relating to the service. The one or more service provider preferences are determined based on the service-context data and service provider data which comprises past behavioural attributes of each of the one or more service providers relating to the service. The one or more consumer preferences are matched with the one or more service provider preferences to identify an optimum service provider from the one or more service providers. The optimum service provider is configured to provide the service to the consumer.

In an embodiment, the present disclosure relates to a non-transitory computer readable medium including instructions stored thereon that when processed by at least one processor cause a device to perform operations for managing services in an online servicing system. Initially, a service-context data is determined for a service request received for a service from a consumer in. an online servicing system. The service-context data is determined based on one or more real-time parameters affecting the service and a service data associated with the service of the consumer. Further, one or more consumer preferences associated with the consumer and one or more service provider preferences associated with one or more service providers are determined. The one or more consumer preferences is determined based on the service-context data and consumer data which comprises past behavioural attributes of the consumer relating to the service. The one or more service provider preferences are determined based on the service-context data and service provider data which comprises past behavioural attributes of each of the one or more service providers relating to the service. The one or more consumer preferences are matched with the one or more service provider preferences to identify an optimum service provider from the one or more service providers. The optimum service provider is configured to provide the service to the consumer.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows exemplary environment of a service management system for managing services in an online servicing system, in accordance with some embodiments of the present disclosure;

FIG. 2 shows a detailed block diagram of a service management system for managing services in an online servicing system, in accordance with some embodiments of the present disclosure;

FIG. 3 illustrates a flowchart showing an exemplary method to manage services in an online servicing system, in accordance with some embodiments of present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The terms “includes”, “including”, or any other variations thereof, are intended to cover a non-exclusive inclusion, such that a setup, device, or method that includes a list of components or steps does not include only those components or steps but may include other components or steps not expressly listed or inherent to such setup or device or method. In other words, one or more elements in a system or apparatus proceeded by “includes . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Present disclosure relates to a method and system for managing services of an online servicing system. The proposed method and system discloses to identify optimum service provider to service opted by a consumer. The optimum service provider may be identified based on preferences of the consumer and one or more service providers, along with service-context data associated with the service. Further, the preferences of the consumer and the one or more service providers are determined in real-time based on previous activities using a neural network. By the proposed method and system, fulfilment of specific service delivery to the consumer with desired service quality may be achieved.

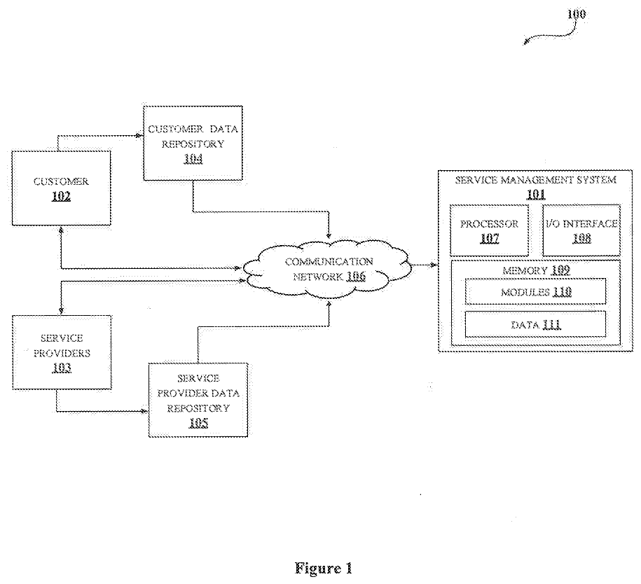

FIG. 1 shows exemplary environment of a service management system 101 for managing services of an online servicing system, in accordance with some embodiments of the present disclosure. The environment 100 may include the service management system 101 in communication with customer 102 and service providers 103, a customer data repository 104, a service provider data repository 105 and a communication network 106. The service management system 101 may be configured to identity optimum service provider to the consumer 102, when a service is opted by the consumer 102 in the online servicing system. In an embodiment, the service management system 101 may be an integral part of the online servicing system. In an embodiment, the service management system 101 may be a dedicated server or a cloud-based server, in communication with the online servicing system. In such case, the service management system 101 may receive required data from at least one of the customer 102, the service providers 103, the customer data repository 104, the service provider data repository 105, and transmit identified optimum service provider to the online servicing system to initiate session of service between the consumer 102 and the optimum service provider.

In an embodiment, the online servicing system may be one of transportation booking service, online shopping service, online medical assistance service, food ordering service, delivery assisting service and so on. One or more other online service including customers and service providers may be managed by the service management system 101 proposed in the present disclosure. The customer 102 and the service providers 103 of the online servicing system may vary based on the services offered the online servicing system. For example, for the transportation booking service, the customer 102 may be a user who has booked a ride to a desired destination using a cab-service application and the service providers 103 may be cab drivers who have registered with the cab-service application, For an online shopping service, the customer 102 may be a user who wishes to buy a product through online service and the service providers 103 may be retail stores who may provision to sell the product online.

The service management system 101 may communicate with the customer 102, the service providers 103, the customer data repository 104 and the service provider data repository 105 via the communication network 106. The communication network 106 may include, without limitation, a direct interconnection, Local Area Network (LAN), Wide Area Network (WAN), wireless network (e.g., using Wireless Application Protocol), the Internet, and the like.

Further, the service management system 101 may include a processor 107, I/O interface 108, and a memory 109. In some embodiments, the memory 109 may be communicatively coupled to the processor 107. The memory 109 stores instructions, executable by the processor 107, which, on execution, may cause the service management system 101 to manage the services of the online servicing system, as disclosed in the present disclosure. In an embodiment, the memory 109 may include one or more modules 110 and data 111. The one or more modules 110 may be configured to perform the steps of the present disclosure using the data 111, to manage the services. In an embodiment, each of the one or more modules 110 may be a hardware unit which may be outside the memory 109 and coupled with the service management system 101. In an embodiment, the service management system 101, for managing the services of the online servicing system, may be implemented in a variety of computing systems, such as a laptop computer, a desktop computer, a Personal Computer (PC), a notebook, a smartphone, a tablet, e-book readers, a server, a network server, a cloud-based server and the like. In an embodiment, the online servicing system may be associated with dedicated service management system 101 to manage the services offered by the online servicing system. In an embodiment, the service management system 101 may be associated with plurality of online servicing systems to manage services offered by each of the plurality of online servicing systems.

In an embodiment, behavioural activities of the customer 102 may be recorded and stored in the customer data repository 104 for each of services opted by the customer 102. Similarly, behavioural activities of each of the service providers 103 may be recorded and stored in the service provider data repository 105 for corresponding services provided by respective service provider. In an embodiment, the customer data repository 104 and the service provider data repository 105 may be integral part of the service management system 101. In an embodiment, the service management system 101. may be configured to record the behavioural activities of the customer 102 and the service providers 103 using one or more techniques known to a person skilled in the art.

The service management system 101 may be configured to manage the services by identifying optimum service provider for a service opted by the customer 102. For enabling a session of the service in the online servicing system, it may be necessary to authenticate the customer 102 with the online servicing system. In an embodiment, before provisioning options of services, provided by the online servicing system, to the customer 102, an option to authenticate the customer 102 may be provided to the customer 102. In an embodiment, the customer 102 may provide predefined authentication details to authenticate with the online servicing system. The service management system 101 may be configured to receive the predefined authentication details from the customer 102 and verify the predefined authentication details to authenticate the customer 102 to use the services provided by the online servicing system. One or more techniques, known to a person skilled in the art, may be implemented to authenticate the customer 102. In an embodiment, the service management system 101 may be configured to authenticate the service providers 103 registered with the online servicing system, before initiating the session of the service with the customer 102.

Upon authentication, option of services offered by the online servicing system may be provided to the customer 102. When the customer 102 selects a service, a service request associated with the service may be generated. Along with the service, the customer 102 may be configured to provide one or more details associated with the service. For example, in a transportation booking session, the customer 102 may select the service of cab and may include the one or more details which may be pickup location, destination location, additional stop points between the pickup location and the destination location and so on. In an embodiment, the service request may include information on the service along with the one or more details.

Upon receipt of the service request, the service management system 101 may be configured to determine a service-context data for the service request. The service-context data may be determined based on one or more real-time parameters affecting the service and a service data associated with the service of the consumer 102. In an embodiment, the service-context represents real-time context of the service opted by the consumer 102. The one or more real-time parameters affecting the service may include time information and location information of the service request, weather information, traffic information at the time generation of the service request and so on. The service data of a service may include list of predefined parameters that may be affecting the service. Using the real-time parameters and the service data, a service context may be generated for the service opted by the consumer 102.

Further, one or more consumer preferences associated with the consumer 102 and one or more service provider preferences associated with one or more service providers are determined by the service management system 101.

The one or more consumer preferences may be determined based on the service-context data and the consumer data. The service management system 101 may retrieve the consumer data from the consumer data repository 104. The consumer data may comprise past behavioural attributes of the consumer 102 relating to the service. In an embodiment, the one or more consumer preferences may be determined using a neural network. The neural network may be configured to assign weights to each of the real-time parameters in relation to each of the past behavioural attributes of the consumer 102. In an embodiment, the weights may be assigned based on at least one of priority, number of occurrences, and nearest frequency of occurrences of corresponding past behavioural attributes. Further, the one or more consumer preferences may be determined based on the weights.

Similarly, the one or more service provider preferences may be determined based on the service-context data and the service provider data. The service management system 101 may retrieve the service provider data from the service provider data repository 105. The service provider data may include past behavioural attributes of each of the one or more service providers relating to the service. In an embodiment, the one or more service providers may be selected amongst plurality of service providers (may be referred as the service providers 103) registered with the online servicing system. Such one or more service providers may be selected to be capable of providing the service to the consumer 102. In an embodiment, preferences of such selected one or more service providers may be determined by the service management system 101. In an embodiment, the one or more service providers tray be selected by verifying availability status of each of the plurality of service providers 103. Further, current location data of each of the plurality of service providers 103 may be validated with location data associated with the service request. Service providers for which successful verification of the availability status and validation of the location data is completed, are selected as the one or more service providers. One or more other techniques, known to a person skilled in the art, may be implemented to select the one or more service providers.

In an embodiment, the one or more service provider preferences for the selected one or more service providers may be determined using service profile. The service profile for each of the one or more service providers may be received by the service management system 101. The service profile may be analysed along with corresponding past behavioural attributes to determine the one or more service provider preferences. In an embodiment, a neural network may be used for determining the one or more service provider preferences. The technique used for determining the one or more consumer preferences may be implemented in the service management system 101 for determining the one or more service provider preferences.

Further, the service management system 101 may be configured to match the one or more consumer preferences with the one or more service provider preferences. By said matching, an optimum service provider from the one or more service providers may be identified for the service opted by the consumer 102. The optimum service provider may be configured to provide the service to the consumer 102. In an embodiment, the one or more consumer preferences are compared with the one or more service provider preferences to identify at least one common preference amongst the one or more consumer preferences and the one or more service provider preferences. The at least one common preference may be identified by comparing the one or more consumer preferences and the one or more service provider preferences. In an embodiment, more than one service provider may have the at least one common preference with the consumer 102. The at least one common preference may be identified by comparing the one or more consumer preferences 212 and the one or more service provider preferences 214. The identified at least one common preference may be verified to be matched between the consumer 102 and corresponding service provider, using threshold value associated with the at least one common preference. In an embodiment, the threshold value may indicate tolerance of deviation in the at least one common preference. In an embodiment, in the service data, the service opted by the consumer 102 may include threshold values associated with each of preferences of the consumer 102 and the one or more service providers. A service provider, from the one or more service providers, associated with the at least one common preference which verified to be matched, may be identified to be the optimum service provider.

Details of the optimum service provider may be communicated with the consumer to initiate the session of the service. In an embodiment, during ongoing of the service, the service management system 101 may be configured to update the service data of the service. For updating during the service, the service management system 101 may be configured to receive current activities of the consumer 102 and the optimum service provider during the service. Further, current service context for the service may be determined based on the current activities. In an embodiment, the steps disclosed in the claimed invention may be implemented to determine the current service context. In an embodiment, the current activities may also be used to identify the threshold associated with each of the preferences of the customer 102 and the optimum service provider. The service management system 101 may be configured to update the service data with the current service context.

In an embodiment, when the service management system 101 receives the service request, the service management system 101 may be configured to identify the service request to be one of new service request and existing service request. When the service request is identified to be the new service request, the service management system 101 may be configured to update the service data for the consumer, with new service context in relation to the new service request. The updated service data may be used when upcoming service request from the customer 102 is the identified as the new service request.

In an embodiment, the service management system 101 may be configured to receive and transmit data via the I/O interface 108. Received data may include the service request, the customer data, the service request data, the service data and so on. Transmitted data may include details of optimum service provider, updated service data and so on.

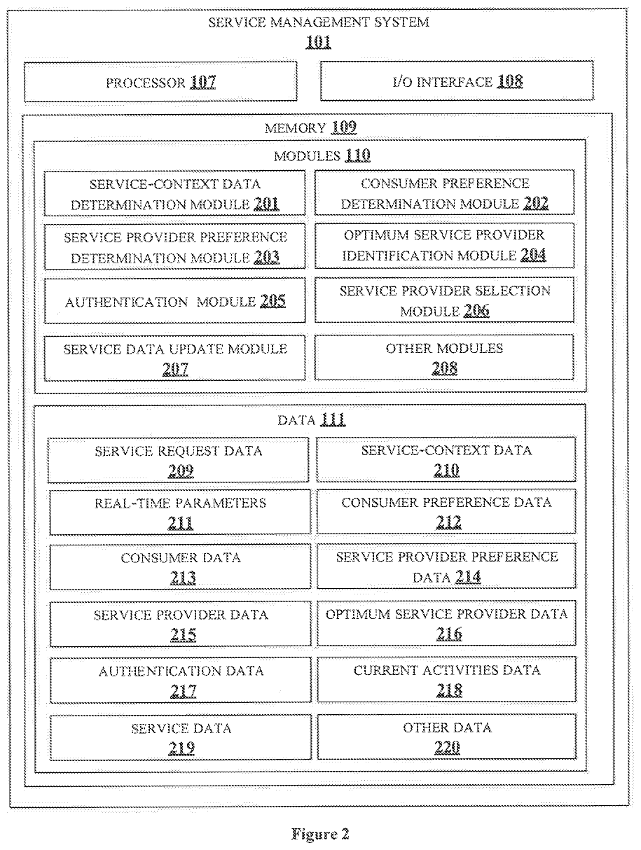

FIG. 2 shows a detailed block diagram of the service management system 101 for managing services in the online servicing system, in accordance with some embodiments of the present disclosure,

The data 111 and the one or more modules 110 in the memory 109 of the service management system 101 is described herein in detail.

In one implementation, the one or more modules 110 may include, but are not limited to, a service-context data determination module 201, a consumer preference determination module 202, a service provider preference determination module 203, an optimum service provider identification module 204, an authentication module 205, a service provider selection module 206, a service data update module 207 and one or more other modules 208, associated with the service management system 101.

In an embodiment, the data 111 in the memory 109 may include service request data 209 (also referred to as service request 209), service-context data 210, real-time parameters 211, consumer preference data 212 (also referred to as one or more consumer preferences 212), consumer data 213, service provider preference data 214 (also referred to as one or more service provider preferences 214), service provider data 215, optimum service provider data 216 (also referred to as optimum service provider 216), authentication data 217, current activities data 218, service data 219 and other data 220 associated with the service management system 101.

In an embodiment, the data 111 in the memory 109 may be processed by the one or more modules 110 of the service management system 101. In an embodiment, the one or more modules 110 may be implemented as dedicated units and when implemented in such a manner, said modules may be configured with the functionality defined in the present disclosure to result in a novel hardware. As used herein, the term module may refer to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality.

The one or more modules 110 of the present disclosure function to manage the services offered by the online servicing system. The one or more modules 110 along with the data 111, may be implemented in any system, for managing the services.

In an online servicing system, a user may be either a consumer or a service provider. The user may be associated with a user interface to obtain or provide any service offered by the online servicing system. The user of the online servicing system may be associated with a user system placed in user transaction terminal. User sub-systems in the user system may be interfaced with the service management system 101 of the online servicing system, to manage the services offered by the online servicing system. In an embodiment, one of the user-subsystems may be responsible to get authentication details from the user. The authentication module 205 of the service management system 101 may be configured to receive such the authenticate details from the user. The user may be one of consumers and service providers associated with the online servicing system. In an embodiment, the authentication details may be log-in credentials predefined by the user. The authentication module 205 may be configured to verify and validate the authentication details to authenticate the user. Such authentication details may be stored as authentication data 217 in the memory 109 of the service management system 101. Upon the authentication, the user may be provided an access to use the online servicing system. The consumer may be authenticated to opt the services offered by the online servicing system and the service provider may be authenticated to provide service opted by the consumer.

In an embodiment, one of the user subsystems may be configured to manage profile of the user. Such subsystem may provision registration of new user, who may be one of a consumer or a service provider, with the online servicing system. Also, the user may be profiled, and profile of a user may include user identification details and user service details. The user identification details may contain the authentication details of the user and the user service details may contain activities of the user while in service. In an embodiment, for a single user, there may be profile with multiple service details associated with different services that the user has availed. The user activities for any service may be stored as corresponding service context for the user.

In an embodiment, the user subsystems may include location module which is configured to collect current location information of the user. In an embodiment, the user subsystems may include weather module which is configured to collect current weather conditions in the location of the user. In an embodiment, the user subsystems may include configuration module, which is configured to hold information on user type, i.e., whether the user is a consumer or a service-provider. Further, based on the user type, the configuration module may configure service manager associated with the user. The service manager may be responsible for managing services for the user. If the user is a consumer, the service manager may place the service request 209 of the consumer to the service management system 101. Also, the service manager may be configured to receive information on the optimum service provider 216 for the requested service to initiate session of the service to the consumer. Similarly, when the user is a service provider who is identified as the optimum service provider 216 for the consumer, the service manager may be configured to assign the service to the user and initiate the session of service to the service provider. In act embodiment, while the service is in progress, the service manager of a user may be configured to record current activities 218 of the user and provide the current activities 218 to the service management system 101. In an embodiment, when the session of the service is completed, the service manager of the user may be configured to collect feedback for the service from the user. The feedback may be provided to the service management system 101. In an embodiment, the user may be associated with a communication manager which may be responsible to establish communication between the user and the service management system 101.

Consider a user to be a consumer, upon authentication of the consumer, options of services offered by the online servicing system may be provided to the customer. Once the service request 209 is received, the service-context data determination module 201 may be configured to load service data 219 for the service opted by the consumer. The service data 219 may be loaded based on the received service request 209. The service data 219 may also be referred to as the service specification and may include information and parameters associated with the service. In an embodiment, the service data 219 associated with a service may contain unique service identification details of the service along with parameters associated with the service. In an embodiment, the service data 219 may be specific to the consumer and the service opted by the consumer. Such service data 219 may include list of parameters or preferences identified for the consumer and thresholds for each of the preferences. For example, for an online shopping service and for a service of buying a product, the service data 219 may include parameters to be time, date, season, location, price, availability, product ratings, payment choice and so. In an embodiment, the threshold associated with a preference may be defined dynamically using one or more one or more factors the preference. For example, the one or more factors may include default priority of the preference as per the service specification. In an embodiment, the one or more factors may include number of occurrences of the preference in past activities of the consumer. For example, consider the preference is product rating. The one or more factors may be number of times the consumer has chosen the product based the product rating. Further, the one or more factors may include nearest frequency of the occurrences of the preference. For example, for couple of instances, number of times the consumer has done the product selection based on product rating.

Further, the service-context data determination module 201 may also be configured to fetch real-time parameters 211 affecting the service. The real-time parameters 211 may include time of the service request 209, type of day, weather conditions, season information and so on. In an embodiment, one or more modules at consumer end may be used to retrieve the real-time parameters 211. For example, the service-context data determination module 201 may be configured to retrieve real-time location information from the location module associated with the consumer. The service-context data determination module 201 may be configured to retrieve real-time weather conditions from the weather module associated with the consumer.

Based on the service data 219 and the real-time parameters 211, the service-context data determination module 201 may be configured to determine the service-context data. In an embodiment, the service-context data 210 may indicate current service-context of the consumer for the service with the real-time parameters 211 affecting the service of the consumer with corresponding thresholds. In an embodiment, the service-context data determination module 201 may be configured to load threshold value for each of the real-time parameters 211 based existing threshold in the service data 219 and the real-time parameters 211. Consider, the online servicing system to be an online ride booking system. The service-context data determination module 201 may be configured to check date and determine if the date of booking is a weekday, weekend or holiday. Further, the service-context data determination module 201 may be configured to check time and determine timeslot of the service to be one of early morning, morning, noon, afternoon, evening and late night. Each of the timeslots may be associated with an ID and corresponding ID, upon determination of the timeslot, may be included in the service context-data. The determination of the timeslot may be performed using Table 1 provided below:

TABLE 1

| Time range | Time slot | Time slot ID |
|---|---|---|
| 5 a.m.-8 a.m. | Early Morning | Timeslot ID: 1 |
| 8 a.m.-12 p.m. | Morning | Timeslot ID: 2 |
| 12 p.m.-3 p.m. | Noon | Timeslot ID: 3 |
| 3 p.m.-6 p.m. | Afternoon | Timeslot ID: 4 |
| 6 p.m.-9 p.m. | Evening | Timeslot ID: 5 |
| 9 p.m.-5 a.m. | Late Night | Timeslot ID: 6 |

Further, the service-context data determination module 201 may be configured to read current weather ID based on weather details received from the weather module. In an embodiment, the weather details may be retrieved by providing longitude and latitude of source of the trip. In an embodiment, the weather details may be read using Table 2 provided below:

TABLE 2

| Weather ID | Season | Main |
|---|---|---|
| Weather ID: 803 | Summer | Cloudy |
| Whether ID: 800 | Summer | Clear Sky |

Further, the service-context data determination module 201 may be configured read location ID of the trip location from the location details provided by the location module. In an embodiment, the location details may be retrieved by providing longitude and latitude of source of the trip.

For said ride booking service, the service-context data determination module 201 may determine the service-context data 210 to be as indicated below:
[Day Type], [Timeslot ID], [location ID], [Weather ID]

The service-context data determination module 201 may be configured to determine the service-context data 210 for any service requested by the consumer using similar techniques. Contents of the service-context data 210 may vary based on the service and the online servicing system.

Further, the consumer preference determination module 202 may be configured to determine the one or more consumer preferences 212 associated with the consumer. The one or more consumer preferences 212 may be built using past behavioural activities of the consumer. In an embodiment, the consumer preference determination module 202 may be configured to retrieve profile of the consumer and the consumer data 213 from a repository associated with a consumer. The consumer data 213 may include past behavioural activities of the consumer relating to the service. For example, the past behavioural activities may include payment mode used by consumer for the service, destination selected by the consumer from a particular pick-up point, time at which a service was opted and so on. In an embodiment, the profile may include service ID and consumer ID for the received service request 209. The consumer data 213 and the profile may be analysed by the consumer preference determination module 202, with respect to the service-context data 210, to determine the one or more consumer preferences 212. In an embodiment, the consumer preference determination module 202 may be configured to create a neural network to determine the one or more consumer preferences 212. In an embodiment, the neural network contains weights to the real-time parameters 211 that help to fetch the one or more consumer preferences 212 for the consumer. The weights of the neuron network may be determined using factors such as priority, number of occurrences, and nearest frequency of occurrences of corresponding past behavioural attributes. In an embodiment, the priority of the real-time parameters 211 are given based on the service data 219 along with the service-context data 210. In an embodiment, the number of occurrences, and the nearest frequency of occurrences may be consider for predefined number of instances of the service. For example, consider for 100 online shopping data stored for a consumer, the consumer has used first payment mode 90 times for payment and has used second payment mode 10 times. Number of occurrences using the first payment mode is 90 and number of occurrences using the second payment mode is 10. However, for last 10 instances, the consumer had used the second payment mode for the payment. Hence, the nearest frequency of occurrences for the second payment mode may be determined to be more than the first payment mode, though the number of occurrences for the first payment mode is more than the second payment mode. The weights assigned to the real-time parameters 211 are dynamic and may be decided based on the past behavioural activities exhibited by the consumer.

Consider an online ride-booking service. The priority of the real-time parameters 211 may be as below:
Timeslot>Location>Day Type>Weather
   where, timeslot is provided with highest priority and weather is provided with least priority,

Based on the above priority, consider the consumer prefers to travel without AC in winter whether it is day or night, When a ride is booked, fetched data for AC will be “switched off”. In this case, even though the priority of the weather is less, but since the number of occurrences for switching off AC in winter is highest, it provides preference of AC to be switched off.

In another example, the consumer who used to book a ride in morning to go to his office is booking a ride to go to the hospital for last couple of days. Fetched data for the consumer may be hospital instead of office next time a ride is booked. In this case, since value for the nearest occurrence of the parameter is high, the weights assigning to the preference may be influenced by the nearest occurrence instead of the priority or the number of occurrences.

Further the service provider preference determination module 203 may be configured to determine the one or more service provider preferences 214 for the one or more service providers. In an embodiment, the service provider selection module 206 may be configured to select one or more service providers amongst plurality of service providers registered with the online servicing system. Such one or more service providers may be selected to be capable of providing the service to the consumer. When the service request 209 is received, the service provider selection module 206 may be configured to send a request to the plurality of service providers of the online servicing system. In an embodiment, service providers may respond to the request to confirm availability status. The availability status from the service provider provides information on the service provider to be one of available and unavailable. Also, current location data of the service providers may be communicated with the service provider selection module 206. If the service provider is not available, or if the service provider is not suitable for the service based on its current location data, session of the service with such service provider is configured to end. If the service provider is available and also found suitable for the service, then the service provider may be selected to be one of the one or more service providers. Preference of only such service providers may be determined by the service provider preference determination module 203.

For determining the one or more service provider preferences 214, the service provider preference determination module 203 may be configured to retrieve the profile of each of the one or more service providers and the service provider data 215. The service provider data 215 include list of past behavioural activities of the one or more service providers. The service provider preference determination module 203 may analyse the profile and the service provide data in view of the service context data, to determine the one or more service provider preferences 214. In an embodiment, a neural network, similar to the neural network used for building the one or more consumer preferences 212, may be implemented in the service provider preference determination module 203 to determine the one or more service provider preferences 214.

Further, the optimum service provider identification module 204 may be configured to match the one or more consumer preferences 212 with the one or more service provider preferences 214. By said matching, an optimum service provider 216 from the one or more service providers may be identified for the service opted by the consumer. The optimum service provider 216 may be configured to provide the service to the consumer. In an embodiment, the optimum service provider identification module 204 may be compare the one or more consumer preferences 212 with the one or more service provider preferences 214 to identify at least one common preference amongst the one or more consumer preferences 212 and the one or more service provider preferences 214. In an embodiment, more than one service provider and the consumer 102 may be associated with the at least one common preference. The identified at least one common preference may be verified to be matched between the consumer 102 and corresponding service provider, using threshold value associated with the at least one common preference. In an embodiment, the threshold value may indicate tolerance of deviation between in the at least one common preference. In an embodiment, in the service data 219, the service opted by the consumer 102 may include threshold values associated with each of preferences of the consumer 102 and the one or more service providers. A service provider, from the one or more service providers, associated with the at least one common preference which verified to be matched may be identified to be the optimum service provider 216. For example, consider the consumer 102 who is a passenger in a car prefers car temperature to be 250 C. A service provider who is driver prefers car temperature to be 270 C. Here, car temperature may be identified to be the at least one common preference between the consumer 102 and the service provider. Since the temperature value is not matching, the at least one common preference may not valid. However, consider the threshold value associated with the preference of car temperature is ±5 which indicates tolerance level of deviation in the preference. In this case, at least one common preference may be verified and said service provider may be selected to be the optimum service provider 216.

In an embodiment, the optimum service provider 216 may be sent a request to start the session of the service. When the optimum service provider 216 accepts the request, communication between the consumer and the optimum service provider 216 may be established. In case, the optimum service provider 216 denies the request, the optimum service provider identification module 204 may be configured to perform re-matching of preferences of the consumer with preferences of other one or more service providers other than the optimum service provider 216 and identify optimum service provider 216 from the other one or more service providers. The optimum service provider identification module 204 may be configured to perform the re-matching and identify the optimum service provider 216, until the request is accepted by the optimum service provider 216.

Details of the optimum service provider 216 may be communicated with the customer to initiate the session of the service. In an embodiment, during ongoing of the service, the service data update module 207 may be configured to update the service data 219 of the service. For updating, during the service, the service data update module 207 may be configured to receive current activities of the consumer 102 and the optimum service provider 216. Further, current service context of the service is determined based on the current activities 218. The service data update module 207 may be configured to update the service data 219 with the current service context.

Further, in arc embodiment, upon receipt of the service request 209 from the consumer, the service data update module 207 may be configured to identify the service request 209 to be one of new service request and existing service request. When the service request 209 is identified to be the new service request, the service management system 101 may be configured to update the service data 219 for the consumer, with the new service request.

In an embodiment, the service data update module 207 module may be configured to request administrator of the service management system to update the service data 219. In an embodiment, the administrator may be configured to authenticate the request, and provision access to the service data update module 207 to update the service data 219. The access may include addition or modification of new or existing service data. One or more techniques, known to a person, skilled in the art may be implemented for performing the authentication and provision access to the service data update module 207.

In an embodiment, based on the current activities 218 and feedback associated with the consumer and the optimum service provider 216, the service data update module 207 may be configured to determine fulfilment rate of the service. Fulfilment rate may indicate service quality and satisfactory levels of both the consumer and the optimum service provider 216.

The other data 220 may store data, including temporary data and temporary files, generated by modules for performing the various functions of the service management system 101. The one or more modules 110 may also include other modules 208 to perform various miscellaneous functionalities of the service management system 101. It will be appreciated that such modules may be represented as a single. module or a combination of different modules,

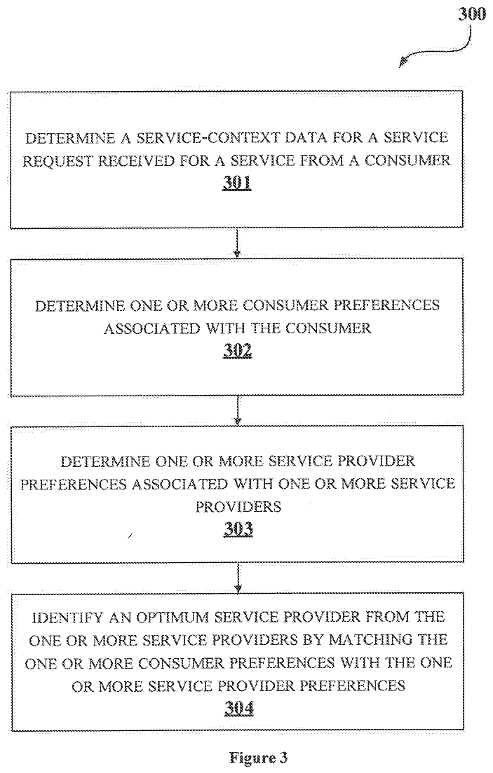

FIG. 3 illustrates a flowchart showing an exemplary method to manage service offered by the online servicing system, in accordance with some embodiments of present disclosure.

At block 301, the service-context determine module 201 may be configured to determine the service-context data 210 for the service request 209. The service-context data 210 may be determined based on the one or more real-time parameters 211 affecting the service and the service data 219 associated with the service of the consumer.

At block 302, the consumer preference determination module 202 may be configured to determine the one or more consumer preferences 212 based on the service-context data 210 and the consumer data 213. The consumer data 213 may comprise past behavioural attributes of the consumer relating to the service. In an embodiment, the one or more consumer preferences 212 may be determined using a neural network. The neural network may be configured to assign weights to each of the real-time parameters 211 in relation to each of the past behavioural attributes of the consumer. In an embodiment, the weights may be assigned based on at least one of priority, number of occurrences, and nearest frequency of occurrences of corresponding past behavioural attributes. Further, the one or more consumer preferences 212 may be determined based on the weights.

At block 303, the service provider preference determination module 203 may be configured to determine the one or more service provider preferences 214 based on the service-context data 210 and the service provider data 215. The service management system 101 may retrieve the service provider data 215 from the service provider data repository 105. The service provider data 215 may comprise past behavioural attributes of each of the one or more service providers relating to the service. In an embodiment, the one or more service providers may be selected amongst plurality of service providers registered with the online servicing system. Such one or more service providers may be selected to be capable of providing the service to the consumer. In an embodiment, preferences of such selected one or more service providers may be determined by the service provider preference determination module 203. In an embodiment, the one or more service providers may be selected by verifying availability status of each of the plurality of service providers. Further, current location data of each of the plurality of service providers is validated with location data associated with the service request 209. Service providers for which successful verification of the available status and validation of the location data is completed, are selected as the one or more service providers.

At block 304, the optimum service provider identification module 204 may be configured to identify an optimum service provider 216 from the one or more service providers. The one or more service provider preferences 214 are matched with the one or more consumer preferences 212 to identify the optimum service provider 216. The optimum service provider 216 may be configured to provide the service to the consumer. In an embodiment, the one or more consumer preferences 212 are compared with the one or more service provider preferences 214 to identify at least one common preference amongst the one or more consumer preferences 212 and the one or more service provider preferences 214. The at least one common preference may be identified by comparing the one or more consumer preferences 212 and the one or more service provider preferences 214. The identified at least one common preference may be verified to be matched between the consumer 102 and corresponding service provider, using threshold value associated with the at least one common preference. A service provider, from the one or more service providers, associated with the at least one common preference which verified to be matched may be identified to be the optimum service provider 216.

As illustrated in FIG. 3, the method 300 may include one or more blocks for executing processes in the service management system 101. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described may not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

### Computing System

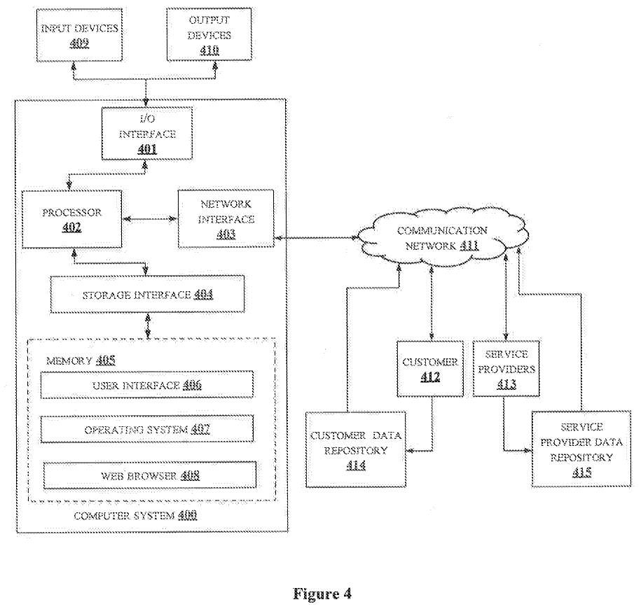

FIG. 4 illustrates a block diagram of an exemplary computer system 400 for implementing embodiments consistent with the present disclosure. In an embodiment, the computer system 400 is used to implement the service management system 101. The computer system 400 may include a central processing unit (“CPU” or “processor”) 402. The processor 402 may include at least one data processor for executing processes in Virtual Storage Area Network. The processor 402 may include specialized processing units such as, integrated system (bus) controllers, memory management control units, floating point units, graphics processing units, digital signal processing units, etc.

The processor 402 may be disposed in communication with one or more input/output (I/O) devices 409 and 410 via I/O interface 401. The I/O interface 401 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 401, the computer system 400 may communicate with one or more I/O devices 409 and 410. For example, the input devices 409 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 410 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 400 may consist of the service management system 101. The processor 402 may be disposed in communication with the communication network 411 via a network interface 403. The network interface 403 may communicate with the communication network 411. The network interface 403 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 411 may include, without limitation, a direct interconnection, local area network (LAN), wide area network (WAN), wireless network (e.g., using Wireless Application Protocol), the Internet, etc. Using the network interface 403 and the communication network 411, the computer system 400 may communicate with customer 412, service providers 413, customer data repository 414 and service provider data repository 415 for managing services in an online servicing system. The network interface 403 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network. 411 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as, serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407, web browser etc. In some embodiments, computer system 400 may store user/application data 406, such as, the data, variables, records, etc., as described in this disclosure. Such databases may be implemented as fault-tolerant, relational, scalable, secure databases such as Oracle ® or Sybase®.

In some embodiments, the computer system 400 may implement a web browser 408 stored program component. The web browser 408 may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers 508 may utilize facilities such as AJAX, DHTML, Adobe Flash, JavaScript, Java, Application Programming Interfaces (APIs), etc. In some embodiments, the computer system 400 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

The operating system 407 may facilitate resource management and operation of the computer system 400. Examples of operating systems include, without limitation, APPLE MACINTOSH® OS X, UNIX®, UNIX-like system distributions (E.G., BERKELEY SOFTWARE DISTRIBUTION198 (BSD), FREEBSD™, NETBSD™, OPENBSD™, etc.), LINUX DISTRIBUTIONS™ (E.G., RED HAT™, UBUNTU™, KUBUNTU™, etc.), IBM™ OS2, MICROSOFT™ WINDOWS™ (XP™, VISTA™/7/8, 10 etc.), APPLE® IOS™, GOOGLE® ANDROID™, BLACKBERRY® OS, or the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, which may be non-transitory. Examples include Random Access Memory (RAM), Read-Only Memory (ROM), volatile memory, non-volatile memory, hard drives, CD ROMs, DVDs, flash drives, disks, and any other known physical storage media.

An embodiment of the present disclosure provisions to consider past behavioural activities of consumer and service providers to identify opium service provider to the consumer. By which, accurate identification of the optimum service provide may be achieved.

An embodiment of the present disclosure provisions to determine preferences dynamically, by considering context of the service, real-time parameters affecting the service and behaviours of the consumer and the service providers. By dynamically determining the preferences, accuracy of the determined preferences may be high.

An embodiment of the present disclosure provisions fulfilment of specific service delivery to the consumer with desired service quality,

The described operations may be implemented as a method, system or article of manufacture using standard programming and/or engineering techniques to produce software, firmware, hardware, or any combination thereof The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media may include all computer-readable media except for a transitory. The code implementing the described operations may further be implemented in hardware logic (e.g., an integrated circuit chip, Programmable Gate Array (PGA), Application Specific Integrated Circuit (ASIC), etc.).

An “article of manufacture” includes non-transitory computer readable medium, and/or hardware logic, in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified, or removed. Moreover, steps may be added to the above described logic and still conform to the described embodiments, Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 100 | Environment |
| 101 | Service management system |
| 102 | Customer |
| 103 | Service providers |
| 104 | Customer data repository |
| 105 | Service provider data repository |
| 106 | Communication network |
| 107 | Processor |
| 108 | I/O interface |
| 109 | Memory |
| 110 | Modules |
| 111 | Data |
| 201 | Service-context data determination module |
| 202 | Consumer preference determination module |
| 203 | Service provider preference determination module |
| 204 | Optimum service provider identification module |
| 205 | Authentication module |
| 206 | Service provider selection module |
| 207 | Service data update module |
| 208 | Other modules |
| 209 | Service request data |
| 210 | Service-context data |
| 211 | Real-time parameters |
| 212 | Consumer preference data |
| 213 | Consumer data |
| 214 | Service provider preference data |
| 215 | Service provider data |
| 216 | Optimum service provider data |
| 217 | Authentication data |
| 218 | Current activities data |
| 219 | Service data |
| 220 | Other data |
| 400 | Computer System |
| 401 | I/O Interface |
| 402 | Processor |
| 403 | Network Interface |
| 404 | Storage Interface |
| 405 | Memory |
| 406 | User Interface |
| 407 | Operating System |
| 408 | Web Browser |
| 409 | Input Devices |
| 410 | Output Devices |
| 411 | Communication Network |
| 412 | Customer |
| 413 | Service providers |
| 414 | Customer data repository |
| 415 | Service provider data repository |

We claim:

1. A method of managing services in an online servicing system, the method comprising:
determining, by a service management system, a service-context data for a service request received for a service from a consumer in an online servicing system, based on one or more real-time parameters affecting the service and a service data associated with the service of the consumer;
determining, by the service management system, one or more consumer preferences associated with the consumer, based on the service-context data and consumer data, wherein the consumer data comprises past behavioral attributes of the consumer relating to the service;
determining, by the service management system, one or more service provider preferences associated with each of the one or more service providers, based on the service-context data and service provider data, wherein the service provider data comprises past behavioural attributes of each of the one or more service providers relating to the service; and
identifying, by the service management system, an optimum service provider from the one or more service providers by matching the one or more consumer preferences with the one or more service provider preferences, wherein the optimum service provider is configured to provide the service to the consumer.

2. The method as claimed in claim 1 further comprising authenticating, by the service management system, the consumer upon receiving the service request.

3. The method as claimed in claim 1, wherein determining the one or more consumer preferences is performed using a neural network by:
assigning weights to each of the real-time parameters in relation to each of the past behavioural attributes of the consumer, based on at least one of priority, number of occurrences, and nearest frequency of occurrences of corresponding past behavioural attributes; and
determining the one or more consumer preferences based on the weights.

4. The method as claimed in claim 1 further comprising selecting, by the service management system, the one or More service providers to be capable of providing the service to the consumer, from plurality of service providers registered with the online servicing system.

5. The method as claimed in claim 4, wherein selecting of the one or more service providers comprises:
verifying availability status of each of the plurality of service providers;
validating current location data of each of the plurality of service providers with location data associated with the service request; and
selecting the one or more service providers from the plurality of service providers based on verifying the availability status and validating the current location data.

6. The method as claimed in claim I, wherein determining the one or more service provider preferences is performed by:
receiving service profile for each of the one or more service providers; and
analysing the service profile and the past behavioural attributes of the service provider to determine the one or more service provider preferences.

7. The method as claimed in claim 1, wherein matching of the one or More consumer preferences with the one or more service provider preferences comprises:
comparing the one or more consumer preferences with the one or more service provider preferences to identify at least one common preference;
verifying the at least one common preference to be matched between the consumer and corresponding service providers, using threshold value associated with the at least one common preference; and
identifying a service provider, from the one or more service providers, associated with the at least one common preference verified to be matched, to be the optimum service provider.

8. The method as claimed in claim 1 further comprising:
receiving, by the service management system, current activities of the consumer and the optimum service provider during the service;
determining, by the service management system, current service context for the service, based on the current activities; and
updating, by the service management system, the service data with the current service context.

9. The method as claimed in claim 1 further comprising:
identifying, by the service management system, the service request to be one of new service request and existing service request; and
updating, by the service management system, the service data for the consumer, with new service context, in relation to the new service request.

10. A service management system for managing services in an online servicing system, the service management system comprises:
a processor; and
a memory communicatively coupled to the processor, wherein the memory stores processor-executable instructions, which, on execution, cause the processor to:
determine a service-context data for a service request received for a service from a consumer in an online servicing system, based on one or more real-time parameters affecting the service and a service data associated with the service of the consumer;
determine one or more consumer preferences associated with the consumer, based on the service-context data and consumer data, wherein the consumer data comprises past behavioural attributes of the consumer relating to the service;
determine one or more service provider preferences associated with each of the one or more service providers, based on the service-context data and service provider data, wherein the service provider data comprises past behavioural attributes of each of the one or more service providers relating to the service; and
identify an optimum service provider from the one or more service providers by matching the one or more consumer preferences with the one or more service provider preferences, wherein the optimum service provider is configured to provide the service to the consumer.

11. The service management system as claimed in claim 10 further comprises the processor configured to authenticate the consumer upon receiving the service request.

12. The service management system as claimed in claim 10, wherein the one or more consumer preferences are determined using a neural network by:
assigning weights to each of the real-time parameters in relation to each of the past behavioural attributes of the consumer, based on at least one of priority, number of occurrences, and nearest frequency of occurrences of corresponding past behavioural attributes: and
determining the one or more consumer preferences based on the weights.

13. The service management system as claimed in claim 10 further comprises the processor configured to select the one or more service providers to be capable of providing the service to the consumer, from plurality of service providers registered with the online servicing system.

14. The service management system as claimed in claim 13, wherein the one or more service providers are selected by:
verifying availability status of each of the plurality of service providers;
validating current location data of each of the plurality of service providers with location data associated with the service request; and
selecting the one or more service providers from the plurality of service providers based on verifying the availability status and validating the current location data.

15. The service management system as claimed in claim 10, wherein the one or more service provider preferences are determined by:
receiving service profile for each of the one or more service providers; and
analysing the service profile and the past behavioural attributes of the service provider to determine the one or more service provider preferences.

16. The service management system as claimed in claim 10, wherein the one or more consumer preferences are matched with the one or more service provider preferences by;
comparing the one or more consumer preferences with the one or more service provider preferences to identify at least one common preference;
verifying the at least one common preference to be matched between the consumer and corresponding service providers, using threshold value associated with the at least one common preference; and
identifying a service provider, from the one or more service providers, associated with the at least one common preference verified to be matched, to be the optimum service provider.

17. The service management system as claimed in claim 10 further comprises the processor configured to:
receive current activities of the consumer and the optimum service provider during the service;
determine current service context of the service, based on the current activities; and
update the service data with the current service context.

18. The service management system as claimed in claim 10 further comprises the processor configured to:
identify the service request to be one of new service request and existing service request; and
update the service data with new service context in relation o the new service request.

19. A non-transitory computer readable medium including instructions stored thereon that when processed by at least one processor cause a device to perform operations comprising:
determining a service-context data for a service request received for a service from a consumer in an online servicing system, based on one or more real-time parameters affecting the service and a service data associated with the service of the consumer;
determining one or more consumer preferences associated with the consumer, based on the service-context data and consumer data, wherein the consumer data comprises past behavioral attributes of the consumer relating to the service;
determining one or more service provider preferences associated with each of the one or more service providers, based on the service-context data and service provider data, wherein the service provider data comprises past behavioural attributes of each of the one or more service providers relating to the service; and
identifying an optimum service provider from the one or more service providers by matching the one or more consumer preferences with the one or more service provider preferences, wherein the optimum service provider is configured to provide the service to the consumer.

20. The medium as claimed in claim 19, wherein the one or more consumer preferences are determined using a neural network by:
assigning weights to each of the real-time parameters in relation to each of the past behavioural attributes of the consumer, based on at least one of priority, number of occurrences, and nearest frequency of occurrences of corresponding past behavioural attributes; and
determining the one or more consumer preferences based on the weights,
wherein the one or more service provider preferences are determined by:
receiving service profile for each of the one or more service providers; and
analysing the service profile and the past behavioural attributes of the service provider to determine the one or more service provider preferences.
